(19) United States
(12) Patent Application Publication
(10) Pub. No.: US 2010/0119789 A1
(43) Pub. Date: May 13, 2010

(54) Advanced conductive ink

(76) Inventor: William J. Grande, Pittsford, NY (US)

Correspondence Address: NIXON PEABODY LLP - PATENT GROUP, 1100 CLINTON SQUARE, ROCHESTER, NY, 14604, US

(21) Appl. No.: 11/398,004

(22) Filed: Apr. 5, 2006

Related U.S. Application Data
(60) Provisional application No. 60/668,668, filed on Apr. 6, 2005.

(51) Int. Cl. C09D 11/02; B05D 3/02; B32B 5/16; B32B 3/10; H01B 1/20; H01B 1/22

(52) U.S. Cl. 428/208; 427/383.1; 428/206; 252/512; 252/503; 977/734; 977/742; 977/750; 977/752

(57) ABSTRACT

The present invention relates to a conductive ink containing fine metallic particles, a polymer base, a solvent, and a nanotube containing conductive filler. Also disclosed is a method of printing conductive ink on a surface where the conductive ink is applied to the surface of a substrate and cured.

This application claims the priority benefit of U.S. Provisional patent application Ser. No. 60/668,668, filed Apr. 6, 2005, which is hereby incorporated by reference in its entirety.

### FIELD OF THE INVENTION

The present invention relates to a conductive ink and a method of printing conductive ink.

### BACKGROUND OF THE INVENTION

Printable conductive inks are used in a broad range of devices including heaters, radio frequency (RF) identification tags, and medical devices. In many of these applications, the substrate upon which the ink is deposited may be required to articulate or may undergo a degree of bending as part of its normal operation. In such applications the conductive ink must flex along with the substrate. This flexing can cause microstructural changes in the cured ink that give rise to increases in resistance and even a failure of continuity. Strain gauge effects will also cause modulations in the resistance of the ink trace, which can give rise to noise and measurement error if the ink trace is used as part of an electrical unit.

FIG. 1 illustrates conductive device trace 10 according to the prior art, which is formed by depositing a conventional ink, identified in FIG. 1 as ink trace 20, on substrate 30. Several compositions for conventional ink are known. In one example, the ink contains fine particles of metal, such as silver, copper, gold, platinum, or graphitic carbon; a polymer base, such as polyester, polyvinyl chloride, silicone rubber or epoxy; and a solvent system to thin the mixture to a workable consistency. “Thermoformable Electrically Conductive Ink 114-311,” manufactured by Creative Materials, Inc. of Tynsboro, Mass., is one such ink.

The present invention is directed to overcoming the limitations in the prior art.

### SUMMARY OF THE INVENTION

One aspect of the present invention relates to a conductive ink containing fine metallic particles, a polymer base, a solvent, and a nanotube containing conductive filler.

Another aspect of the present invention relates to a method of printing conductive ink on a surface. This method involves providing a conductive ink as described above, applying the conductive ink to the surface of a substrate, and curing the conductive ink on the surface.

A further aspect of the present invention relates to a printed surface of a substrate, which includes a substrate with a surface and a cured conductive ink as described above.

The present invention relates to an advanced conductive ink formed by the addition of nanostructured filler materials to conventional conductive inks. The nanostructured filler materials are selected to have high electrical conductivity and high aspect ratio. The nanostructured filler materials create additional conductive pathways through the ink that are not readily disrupted by mechanical bending. Thus, conductive traces formed using this advanced conductive ink suffer less increase in resistance with repeated flexing and exhibit smaller strain gauge effects.

Described herein are the formulation for the advanced conductive ink, and the advanced conductive device trace that results from applying and curing the advanced conductive ink on a substrate. These and other aspects, objects, features, and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a cross-sectional view of a conductive device trace according to the prior art.

FIG. 2 is a cross-sectional view of an advanced conductive device trace according to the present invention.

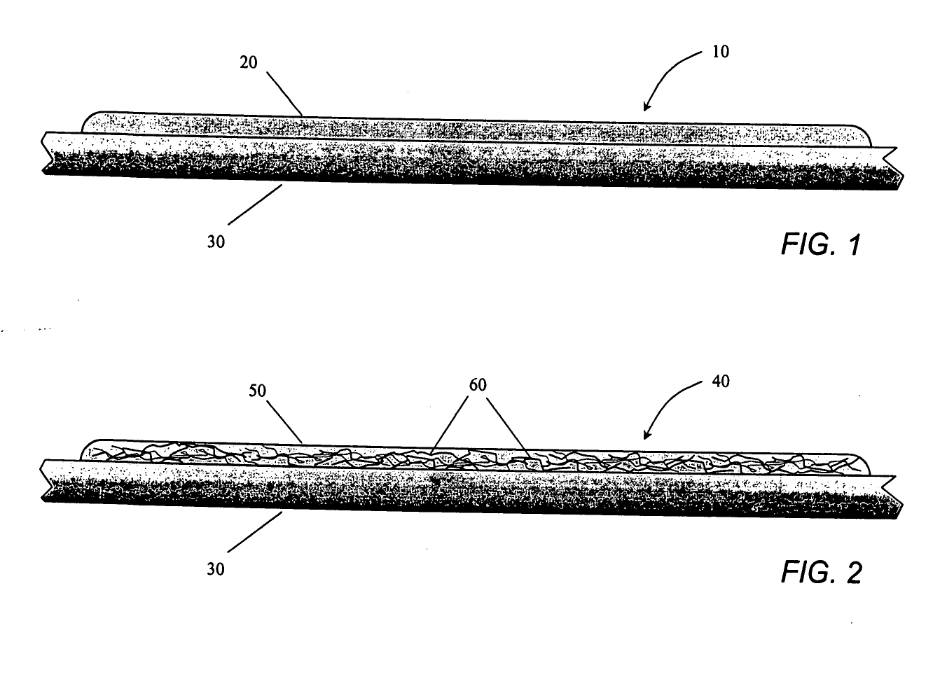

### DETAILED DESCRIPTION OF THE INVENTION

One aspect of the present invention relates to a conductive ink containing fine metallic particles, a polymer base, a solvent, and a nanotube containing conductive filler.

In a preferred embodiment, the fine metallic particles are silver, copper, gold, platinum, palladium, or graphitic carbon. Preferably, the polymer base is a polyester, polyvinyl chloride, silicone rubber, or an epoxy.

The solvent can be any solvent system suitable to thin the mixture to a workable consistency. Suitable solvents include acetone, methyl ethyl ketone, n-methylpyrrolidone, and tetrahydrofuran.

The nanotube containing conductive filler preferably contains one or more of the following: nanometer-sized carbon soot, unrefined carbon nanotubes, refined carbon nanotubes, single-wall carbon nanotubes, multi-wall carbon nanotubes, or nano-whiskers of conductive metals.

Nano-whiskers of conductive metals are preferably made from silver, copper, gold, platinum, titanium, palladium, nickel, or combinations thereof.

Another aspect of the present invention relates to a method of printing conductive ink on a surface. This method involves providing a conductive ink of the present invention, applying the conductive ink to the surface of a substrate, and curing the conductive ink on the surface.

Application of the conductive ink of the present invention to the surface of a substrate may involve any well-known technique of applying or depositing conventional inks. These techniques include, without limitation, screen printing, pad printing, stamping, inkjet printing, capillary dispensing, and all the printing methodologies associated with the graphic arts industry.

Substrates may include any material capable of receiving application of the conductive ink. Suitable substrates include paper, textiles, polymers, glasses, ceramics, and metals coated with a dielectric.

Curing or drying of the conductive ink on the substrate surface may be carried out by well-known techniques for curing or drying a conventional ink trace. Typical curing techniques include, without limitation, air drying, baking at temperatures above room temperature, vacuum baking, the application of electromagnetic radiation, or self-curing via chemical reaction. It is particularly desirable to cure at a temperature of 20 to 150° C.

A further aspect of the present invention relates to a printed surface of a substrate, which includes a substrate with a surface and a cured conductive ink as described above.

FIG. 2 illustrates conductive device trace 40, which is formed by applying a conductive ink of the present invention, identified in FIG. 2 as ink trace 50, on substrate 30. Ink trace 50 contains nanotube conductive filler 60, which creates additional conductive pathways through ink trace 50 that are not readily disrupted by mechanical bending. As a result, ink trace 50 suffers less increase in resistance with repeated flexing and exhibits smaller strain gauge effects than ink traces formed from conventional conductive inks.

Although the invention has been described in detail for the purposes of illustration, it is understood that such detail is solely for that purpose, and variations can be made therein by those skilled in the art without departing from the spirit and scope of the invention which is defined by the following claims.

1. In a conductive ink, the improvement comprises:
fine metallic particles;
a polymer base;
a solvent; and
nanostructured conductive filler.

2. The conductive ink of claim 1, wherein the nanostructured conductive filler is selected from the group consisting of nanometer-sized carbon soot, unrefined carbon nanotubes, refined carbon nanotubes, single-wall carbon nanotubes, multi-wall carbon nanotubes, and nano-whiskers of conductive metals.

3. The conductive ink of claim 2, wherein the nanostructured conductive filler is nano-whiskers of conductive metals, wherein the conductive metal is selected from the group consisting of silver, copper, gold, platinum, titanium, palladium, nickel, and combinations thereof.

4. The conductive ink of claim 1, wherein the fine metallic particles are made from a metal selected from the group consisting of silver, copper, gold, platinum, and palladium.

5. The conductive ink of claim 1, wherein the polymer base is selected from the group consisting of a polyester, polyvinyl chloride, silicone rubber, and an epoxy.

6. A method of printing conductive ink on a surface, said method comprising:
providing a conductive ink comprising:
fine metallic particles;
a polymer base;
a solvent; and
a nanostructured conductive filler;
applying the conductive ink to the surface of a substrate; and
curing the conductive ink on the surface.

7. The method of claim 6, wherein the nanostructured conductive filler is selected from the group consisting of nanometer-sized carbon soot, unrefined carbon nanotubes, refined carbon nanotubes, single-wall carbon nanotubes, multi-wall carbon nanotubes, and nano-whiskers of conductive metals.

8. The method of claim 7, wherein the nanostructured conductive filler is nano-whiskers of conductive metals, wherein the conductive metal is selected from the group consisting of silver, copper, gold, platinum, titanium, palladium, nickel, and combinations thereof.

9. The method of claim 6, wherein the fine metallic particles are made from a metal selected from the group consisting of silver, copper, gold, platinum, and palladium.

10. The method of claim 6, wherein the polymer base is selected from the group consisting of a polyester, polyvinyl chloride, silicone rubber, and an epoxy.

11. The printed surface prepared by the method of claim 6.

12. A printed surface of a substrate comprising:
a substrate with a surface and
a cured conductive ink on the surface of the substrate and comprising:
fine metallic particles;
a polymer base;
a solvent; and
a nanostructured conductive filler.

13. The printed surface of claim 12, wherein the nanostructured conductive filler is selected from the group consisting of nanometer-sized carbon soot, unrefined carbon nanotubes, refined carbon nanotubes, single-wall carbon nanotubes, multi-wall carbon nanotubes, and nano-whiskers of conductive metals.

14. The printed surface of claim 13, wherein the nanostructured conductive filler is nano-whiskers of conductive metals, wherein the conductive metal is selected from the group consisting of silver, copper, gold, platinum, titanium, palladium, nickel, and combinations thereof.

15. The printed surface of claim 12, wherein the fine metallic particles are made from a metal selected from the group consisting of silver, copper, gold, platinum, and palladium.

16. The printed surface of claim 12, wherein the polymer base is selected from the group consisting of a polyester, polyvinyl chloride, silicone rubber, and an epoxy.
